(19) United States
(12) Patent Application Publication
(10) Pub. No.: US 2023/0060274 A1
(43) Pub. Date: Mar. 2, 2023

(54) TEMPERATURE CONTROL SHEETS FOR PACKAGING

(71) Applicant: PHASE CHANGE ENERGY SOLUTIONS, INC., Greensboro, NC (US)

(72) Inventors: Reyad I. Sawafta, Greensboro, NC (US); Venu Gopal Kuturu, Greensboro, NC (US); Rami M. Saeed, Greensboro, NC (US); Firas R. Sawafta, Greensboro, NC (US); Anne McLean, Greensboro, NC (US)

(73) Assignee: PHASE CHANGE ENERGY SOLUTIONS, INC., Greensboro, NC (US)

(21) Appl. No.: 17/796,731

(22) PCT Filed: Jan. 29, 2021
(86) PCT No.: PCT/US2021/015706

§ 371 Date: Aug. 1, 2022

Related U.S. Application Data
(60) Provisional application No. 62/968,149, filed on Jan. 30, 2020.

(51) Int. Cl. F25D 3/06; C09J 7/29; F25D 23/06

(52) U.S. Cl. CPC F25D 3/06; C09J 7/29; F25D 23/06; F25D 2303/0831; F25D 2303/0843; F25D 2303/0844; F25D 2303/0845

(57) ABSTRACT

In one aspect, temperature control sheets are described herein. In some embodiments, such a sheet comprises a first film; a second film facing opposition to the first film; and a phase change material (PCM) component disposed in between the first film and the second film. The sheet comprises one or more PCM-containing zones in a lateral plane of the sheet and also comprises one or more PCM-free fold or cut zones or lines in the lateral plane of the sheet.

### CROSS REFERENCE TO RELATED APPLICATIONS

The present patent application claims the benefit and priority of U.S. Provisional Pat. Application No. 62/968,149, filed on Jan. 30, 2020, titled “TEMPERATURE CONTROL SHEETS FOR PACKAGING,” the contents of which is hereby incorporated by reference in its entirety.

### FIELD

The present disclosure relates to temperature control sheets and packages, in particular, to temperature control sheets and packages comprising phase change materials (PCMs).

### BACKGROUND

Many temperature-sensitive materials, such as foods and medicines, frequently require transportation or shipment from one location to another, over long distances and time periods or over short distances and time periods. In addition, many such shipments are “one way” shipments, in which the packaging and shipping materials are frequently discarded or recycled, rather than being reused. Traditionally, ice packs have been one option used in one-way shipping envelopes. In other instances, expensive multi-use shipping solutions are employed, such as refrigerated trucks or other transport containers relying on mechanical systems for temperature control of the transported payload.

Unfortunately, many existing solutions suffer from one or more disadvantages such as high cost, incompatible form factors, or difficult containerization/storage. For example, some passive materials (such as ice packs) cannot meet thermal energy management requirements, especially for long shipping times and/or under extreme conditions, such as experienced during hot summers or in air freight. In certain cases, ice packs may have an incompatible phase change temperature for the desired payload. Additionally, ice packs may offer limited form factor or shape/size options, limiting the ability to ship a variety of differing sizes or shapes of payloads. Active heating or cooling of packages often requires complex and/or expensive equipment. Further, such equipment may impart shipping or storage risks. For example, a heating or cooling element poses a risk of failed electrical connections, or may introduce risk of overheating or flammability. For at least these reasons, there remains a need for temperature control packaging solutions that are effective over a wide range of shipping conditions.

### SUMMARY

In one aspect, temperature control sheets are described herein. Temperature control sheets described herein comprise a first film, a second film, wherein the second film is facing in opposition to the first film, and a phase change material (PCM) component is disposed in between the first film and the second film. The temperature control sheet comprises one or more PCM-containing zones in a lateral plane of the sheet. The temperature control sheet may also comprise one or more PCM-free fold or cut zones in the lateral plane of the sheet.

In another aspect a temperature control sheet is comprised of a first film and a second film. The first film and the second film are constructed by placing the films together and disposing PCM in between the first film and the second film. The first film and the second film are held in place by a self-adhering film. In further aspects the temperature control sheet includes a third film facing in opposition of the first or second film, and wherein PCM is disposed between the third film and the first or second film. In even further aspects a fourth film may face in opposition to any of the previous films and PCM is disposed between the fourth film and any of the previous films. In the example, the PCM material forms a zone between the first film and the second film (or the third and the fourth film), and in the example of an envelope or mailer forms a lateral plane of the wall or sheet of the envelope or mailer. In the example of a package, in similar fashion to the envelope or mailer, the lateral planes form the walls or sheets of the package. Further, the temperature control sheet, in some embodiments may have a PCM-free fold or cut zone wherein the PCM-free fold or cut zones may be used to fold the envelope, mailer, or package to form an edge or crease.

In another aspect, a method of forming a temperature control package is disclosed herein. Methods of forming temperature control packages described herein comprise placing a payload on the temperature control sheet. Next, cutting the temperature control sheet along one or more PCM-free fold or cut zones of the temperature control sheet. Next, folding the temperature control sheet over the payload. Lastly, adhering at least one film of the sheet to itself or to another film of the sheet, thereby encapsulating the payload.

These and other embodiments are described in greater detail in the description which follows.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure.

FIG. 1 sets forth a perspective view of an illustration of an example of an envelope or mailer with temperature control sheets.

FIG. 2 sets for an additional perspective view of an illustration of an example of an envelope or mailer in open view with temperature control sheets.

FIG. 3 sets forth a perspective view of an illustration of a package in the form of a box in an open lid configuration with temperature control sheets.

FIG. 4 sets forth an additional perspective view of an illustration of a package in the form of a box with a partially open lid configuration with temperature control sheets.

FIG. 5 sets forth an additional perspective view of an illustration of a package in the form of a box with in a closed lid configuration with temperature control sheets.

FIG. 6 sets for an additional perspective view of a cut away illustration of a package in the form of a box highlighting the fold lines with temperature control sheets.

FIG. 7 sets forth an additional perspective view of an illustration of a package in the form of a box in a collapsed configuration with temperature control sheets.

### DETAILED DESCRIPTION

Implementations and embodiments described herein can be understood more readily by reference to the following detailed description, drawings, and examples. Elements, apparatus, and methods described herein, however, are not limited to the specific implementations presented in the detailed description, drawings, and examples. It should be recognized that these implementations are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9. Similarly, as will be clearly understood, a stated range of “1 to 10” should be considered to include any and all subranges beginning with a minimum of 1 or more and ending with a maximum value of 10 or less, e.g., 1 to 6, or 7 to 10, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points of 5 and 10.

In one example, a temperature control sheet described herein comprises a first film, a second film in facing opposition to the first film, and a phase change material (PCM) component disposed in between the first film and the second film. The sheet comprises one or more PCM-containing zones in a lateral plane of the sheet. Additionally, the sheet also comprises one or more PCM-free fold or cut zones or lines in the lateral plane of the sheet. Further, in some cases, the sheet comprises a plurality of PCM-containing zones in the lateral plane of the sheet. The sheet may also comprise a plurality of PCM-free fold or cut zones in the lateral plane of the sheet, as described further herein.

Moreover, in some embodiments, the first film and/or the second film of the sheet is a self-adhering film. Any self-adhering film not inconsistent with the objectives of the present disclosure may be used. For example, in some preferred embodiments, the self-adhering film adheres to itself upon application of pressure. In other instances, the self-adhering film adheres to itself upon application of heat. However, it is to be understood that, in some cases, the self-adhering film of a sheet described herein does not require heat for self-adherence. Similarly, it is further to be understood that, in some instances, the self-adhering film of a sheet described herein does not require or comprise a separate adhesive layer, strip, or area for the purpose of adhering the film to itself. That is, the film material itself can adhere to itself with sufficient strength to form a seam or seal suitable for packaging applications, including for mail or courier shipping.

Such a film, in some embodiments, can have an adhesive side and a non-adhesive side (where it is to be understood that the “adhesive” side does not include a separate adhesive material, distinct from the film material itself, but instead is self-adhering in a manner described hereinabove). For example, in some cases, a first side of the film (e.g., a top side) does not adhere to itself (e.g., even with the application of pressure), while a second side of the film (e.g., a bottom side) does adhere to itself (e.g., with the application of pressure). One non-limiting example of such a film is sold under the Scotch™ Flex and Seal name. Thus, in some preferred embodiments, the first film and/or the second film is, comprises, or is formed from a Scotch Flex and Seal film. Other materials or films may also be used in a sheet described herein. Additionally, in some cases, a film of a sheet described herein can be a thermally insulating sheet or be formed from a thermally insulating material, such as a foam or other thermally insulating material.

Moreover, it is further to be understood that a self-adhering film described herein, despite not requiring a separate adhesive material to achieve adherence to itself, may nevertheless comprise one or more regions comprising a separate adhesive material. For example, in some cases, a self-adhering film described herein can comprise an additional adhesive strip (which may, in some instances, be covered with a removable or peelable paper sheet to protect the adhesive strip from unintended adhesion to various materials). Such an adhesive strip may be disposed on a non-adhesive side (e.g., the top) or an adhesive side (e.g., the bottom) of the self-adhering film. The use of such an adhesive strip may be especially useful for adhering non-adhesive sides of a film together, such as may be needed if a flap or overhang of the first film or second film is folded over the second or first film, respectively, in a manner that the films are not self-adhering without the use of the adhesive (e.g., applying pressure alone will not suffice to adhere the films).

In one example, the walls (e.g. first film and a second film) and or layers (e.g. first film, second film, third film, fourth film) of the temperature control sheets, that form packages, envelopes, or mailers are occupied with any number of PCM components. For instance, a cold application may have PCM with a temperature range from 2-8° C. wherein the PCM absorbs heat to maintain the contents within the mailer or package. Similarly, a heat application may have PCM with a temperature range from 20-25° C. to release heat when changing phase to maintain the contents within the mailer or package. The absorption, storage, and release of thermal energy is dependent upon the PCM mixture and the environment. Moreover, the layers may contain a multiplicity of PCMs each designed for the specific thermal energy and temperature control requirements.

In one example the PCM absorbs or releases large amounts of latent thermal energy during a phase transition process. For example, in one embodiment, when environmental temperatures reach a phase transition temperature, the physical state of the PCM will change from a solid to a liquid, resulting in the absorption of heat. In other embodiments the physical state will change from a liquid to a solid at a specific freezing point, wherein heat is released from the PCM. Additional phase transitions may occur, for instance a solid to solid or a liquid to liquid, or a mesophase transition, to name a few.

In one aspect the temperature controlled sheets provide thermoregulation for medicinal transport. In such an embodiment a mailer with PCM may be used to ship insulin to patients, the typical temperature range for safe storage of insulin is between 13° C. and 26° C. In the example provided a temperature controlled sheet may be designed to mediate and control temperatures within the mailer between 13° C. and 26° C., by using one or more PCM’s as described herein.

In one aspect, temperature control sheets are described herein which, in some embodiments, provide one or more advantages compared to other temperature control packaging solutions. For example, in some cases, a temperature control sheet described herein can help maintain temperature at a wide variety of set points. A temperature control sheet described herein can also have a “dual mode” functionality, making the sheet suitable for use under both hot and cold ambient conditions. Moreover, a temperature control sheet described herein, in some instances, allows end users to package temperature-sensitive payloads in a modular manner, thereby reducing waste.

The PCM component of a sheet described herein can comprise any PCM or combination of PCMs not inconsistent with the objectives of the present disclosure. The PCM (or combination of PCMs) used in a particular instance can be selected based on a relevant operational temperature range for the specific end use or application. As understood by one having ordinary skill in the art, a phase transition temperature described herein (such as a phase transition temperature of “X” °C, where X may be 20° C., for example) may be represented as a normal distribution of temperatures centered on X°C. In addition, as understood by one having ordinary skill in the art, a PCM described herein can exhibit thermal hysteresis, such that the PCM exhibits a phase change temperature difference between the “forward” phase change and the “reverse” phase change (e.g., a solidification temperature that is different from the melting temperature). For example, in some cases, the PCM has a phase transition temperature within a range suitable for transporting a biological payload. In other instances, the PCM has a phase transition temperature suitable for maintaining a temperature close to room temperature. In some embodiments, the PCM has a phase transition temperature within one of the ranges of Table 1 below.

Table 1

Sample of Phase Transition Temperature Ranges for Applicable PCMs
Sample of Phase Transition Temperature Ranges
20-30° C.
20-25° C.
15-35° C.
15-25° C.
10-20° C.
8-15° C.
6-8° C.
2-8° C.
0-5° C.
-5° C. to 0° C.
-15° C. to -5° C.
-25° C. to -15° C.

Further, a PCM of a sheet or package described herein can either absorb or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition. A solid-to-solid transition is also possible.

Moreover, in some cases, a PCM or mixture of PCMs has a phase transition enthalpy of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100 kJ/kg and about 220 kJ/kg, or between about 100 kJ/kg and about 250 kJ/kg.

In addition, a PCM of a sheet or package described herein can have any composition not inconsistent with the objectives of the present disclosure. In some embodiments, for instance, a PCM comprises an inorganic composition. In other cases, a PCM comprises an organic composition. In some instances, a PCM comprises a salt hydrate. Suitable salt hydrates include, without limitation, CaCl₂ • 6H₂O, Ca(NO₃)₂ • 3H₂O, NaSO₄ • 10H₂O, Na(NO₃)₂ • 6H₂O, Zn(NO₃)₂ • 2H₂O, FeCl₃ • 2H₂O, Co(NO₃)₂ • 6H₂O, Ni(NO₃)₂ • 6H₂O, MnCl₂ • 4H₂O, CH₃COONa • 3H₂O, LiC₂H₃O₂ • 2H₂O, MgCl₂ • 4H₂O, NaOH • H₂O, Cd(NO₃)₂ • 4H₂O, Cd(NO₃)₂ • 1H₂O, Fe(NO₃)₂ • 6H₂O, NaAl(SO₄)₂ • 12H₂O, FeSO₄ • 7H₂O, Na₃PO₄ • 12H₂O, Na₂B₄O₇ • 10H₂O, Na₃PO₄ • 12H₂O, LiCH₃COO • 2H₂O, and/or mixtures thereof. The PCM may also be water. In some cases, the PCM is not water.

In other embodiments, a PCM comprises a fatty acid. A fatty acid, in some embodiments, can have a C4 to C28 aliphatic hydrocarbon tail. In some cases, for instance, a PCM comprises one or more of the following a salt hydrate; a fatty acid (e.g., having a C4 to C28 aliphatic hydrocarbon tail, which can be saturated or unsaturated, linear or branched, where a chemical species described as a “Cn” species (e.g., a “C4” species or a “C28” species) is a species of the identified type that includes exactly “n” carbon atoms; thus, a C4 to C28 aliphatic hydrocarbon tail refers to a hydrocarbon tail that includes between 4 and 28 carbon atoms); an alkyl ester of a fatty acid (such as a C2 to C6 ester alkyl backbone or a C6 to C12 ester alkyl backbone or a C12 to C28 ester alkyl backbone); a fatty alcohol (such as a fatty alcohol having a C4 to C28 aliphatic hydrocarbon tail); a fatty carbonate ester, sulfonate, or phosphonate (such as a C4 to C28 alkyl carbonate ester, sulfonate, or phosphonate); a paraffin; a polymeric material (such as a polymeric material). In some cases, the PCM is a PCM sold under the trade name BioPCM®, available from Phase Change Energy Solutions (Asheboro, North Carolina), such as BioPCM-(-8), BioPCM-(-6), BioPCM-(-4), BioPCM-(-2), BioPCM-4, BioPCM-6, BioPCM 08, BioPCM-Q12, BioPCM-Q15, BioPCM-Q18, BioPCM-Q20, BioPCM-Q21, BioPCM-Q23, BioPCM-Q25, BioPCM-Q27, BioPCM-Q30, BioPCM-Q32, BioPCM-Q35, BioPCM-Q37, BioPCM-Q42, BioPCM-Q49, BioPCM-55, BioPCM-60, BioPCM-62, BioPCM-65, BioPCM-69, and others.

Further, in some cases, the hydrocarbon tail is saturated. Alternatively, in other instances, the hydrocarbon tail is unsaturated. In some embodiments, the hydrocarbon tail can be branched or linear. Non-limiting examples of fatty acids suitable for use in some embodiments described herein include caprylic acid, capric acid, lauric acid, myristic acid, palmitic acid, stearic acid, arachidic acid, behenic acid, lignoceric acid, and cerotic acid. In some cases, a PCM described herein comprises a combination, mixture, or plurality of differing fatty acids.

In some instances, a PCM comprises an alkyl ester of a fatty acid. Any alkyl ester not inconsistent with the objectives of the present disclosure may be used. For instance, in some embodiments, an alkyl ester comprises a methyl ester, ethyl ester, isopropyl ester, butyl ester, or hexyl ester of a fatty acid described herein. In other implementations, an alkyl ester comprises a C2 to C6 ester alkyl backbone or a C6 to C12 ester alkyl backbone. In some embodiments, an alkyl ester comprises a C12 to C28 ester alkyl backbone. Further, in some cases, a PCM comprises a combination, mixture, or plurality of differing alkyl esters of fatty acids. Non-limiting examples of alkyl esters of fatty acids suitable for use in some embodiments described herein include methyl laurate, methyl myristate, methyl palmitate, methyl stearate, methyl palmitoleate, methyl oleate, methyl linoleate, methyl docosahexanoate, methyl ecosapentanoate, ethyl laurate, ethyl myristate, ethyl palmitate, ethyl stearate, ethyl palmitoleate, ethyl oleate, ethyl linoleate, ethyl docosahexanoate, ethyl ecosapentanoate, isopropyl laurate, isopropyl myristate, isopropyl palmitate, isopropyl stearate, isopropyl palmitoleate, isopropyl oleate, isopropyl linoleate, isopropyl docosahexanoate, isopropyl ecosapentanoate, butyl laurate, butyl myristate, butyl palmitate, butyl stearate, butyl palmitoleate, butyl oleate, butyl linoleate, butyl docosahexanoate, butyl ecosapentanoate, hexyl laurate, hexyl myristate, hexyl palmitate, hexyl stearate, hexyl palmitoleate, hexyl oleate, hexyl linoleate, hexyl docosahexanoate, and hexyl ecosapentanoate.

In some embodiments, a PCM comprises a fatty alcohol. Any fatty alcohol not inconsistent with the objectives of the present disclosure may be used. For instance, a fatty alcohol, in some cases, can have a C4 to C28 aliphatic hydrocarbon tail. Further, in some embodiments, the hydrocarbon tail is saturated. Alternatively, in other implementations, the hydrocarbon tail is unsaturated. The hydrocarbon tail can also be branched or linear. Non-limiting examples of fatty alcohols suitable for use in some embodiments described herein include capryl alcohol, pelargonic alcohol, capric alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, arachidyl alcohol, heneicosyl alcohol, behenyl alcohol, lignoceryl alcohol, ceryl alcohol, and montanyl alcohol. In some cases, a PCM comprises a combination, mixture, or plurality of differing fatty alcohols.

In some instances, a PCM comprises a fatty carbonate ester, sulfonate, or phosphonate. Any fatty carbonate ester, sulfonate, or phosphonate not inconsistent with the objectives of the present disclosure may be used. In some embodiments, a PCM comprises a C4 to C28 alkyl carbonate ester, sulfonate, or phosphonate. In some embodiments, a PCM comprises a C4 to C28 alkenyl carbonate ester, sulfonate, or phosphonate. In some embodiments, a PCM comprises a combination, mixture, or plurality of differing fatty carbonate esters, sulfonates, or phosphonates. In addition, a fatty carbonate ester described herein can have two alkyl or alkenyl groups described herein or only one alkyl or alkenyl group described herein.

Moreover, in some embodiments, a PCM comprises a paraffin. Any paraffin not inconsistent with the objectives of the present disclosure may be used. In some embodiments, a PCM comprises n-dodecane, n-tridecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, and/or mixtures thereof.

In addition, in some embodiments, a PCM comprises a polymeric material. Any polymeric material not inconsistent with the objectives of the present disclosure may be used. Non-limiting examples of suitable polymeric materials for use in some embodiments described herein include thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600, CARBOWAX® polyethylene glycol 1000, CARBOWAX® polyethylene glycol 1500, CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

It is further to be understood that a sheet or package described herein can comprise a plurality of differing PCMs, including differing PCMs of differing types. Any mixture or combination of differing PCMs not inconsistent with the objectives of the present disclosure may be used. In some embodiments, for example, a sheet or package comprises one or more fatty acids and one or more fatty alcohols. Further, as described above, a plurality of differing PCMs, in some cases, is selected based on a desired phase transition temperature and/or latent heat of the mixture of PCMs.

Further, in some embodiments, one or more properties of a PCM described herein can be modified by the inclusion of one or more additives. Such an additive described herein can be mixed with a PCM and/or otherwise disposed in a sheet or package described herein. In some embodiments, an additive comprises an antimicrobial material. Any antimicrobial material not inconsistent with the objectives of the present disclosure may be used. An antimicrobial material, in some cases, comprises an inorganic composition, including metals and/or metal salts. In some embodiments, for example, an antimicrobial material comprises metallic copper, zinc, or silver or a salt of copper, zinc, or silver. Moreover, in some instances, an antimicrobial material comprising a metal can also provide thermal conductivity modulation. In other embodiments, an antimicrobial material comprises an organic composition, including natural and synthetic organic compositions. In some cases, an antimicrobial material comprises a β-lactam such as a penicillin or cephalosporin. In some implementations, an antimicrobial material comprises a protein synthesis inhibitor such as neomycin. In some embodiments, an antimicrobial material comprises an organic acid, such as lactic acid, acetic acid, or citric acid. In some cases, an antimicrobial material comprises a quarternary ammonium species. A quarternary ammonium species, in some embodiments, comprises a long alkyl chain, such as an alkyl chain having a C8 to C28 backbone. In some instances, an antimicrobial material comprises one or more of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide.

In other embodiments, an additive comprises a nucleating agent. A nucleating agent, in some embodiments, can help avoid subcooling, particularly for PCMs comprising finely distributed phases, such as fatty alcohols, paraffinic alcohols, amines, and paraffins. Any nucleating agent not inconsistent with the objectives of the present disclosure may be used.

Moreover, the PCM component of a temperature controlled sheet described herein can have any size, shape, or structure not inconsistent with the objectives of the present disclosure. For example, in some cases, the PCM component comprises a mat or sheet comprising one or more pouches or pockets that contain or are filled with PCM. Such a mat or sheet, in some cases, is formed from plastic or other polymer. Further, in some embodiments, such a mat or sheet comprises a plurality of PCM-containing pockets or pouches, as well as connecting regions in between the pockets or pouches, such as flat plastic sheet areas that join the pockets or pouches to one another but do not themselves contain PCM. Additionally, the pockets or pouches can have any size or shape desired. In some instances, the pockets or pouches are relatively small compared to the total seize of the sheet or mat. Such a configuration can permit the overall PCM component (the mat or sheet) to be easily folded or cut in numerous places and numerous directions (e.g., anywhere in between the numerous pouches or pockets), without releasing PCM or folding PCM over itself. A PCM component described herein may also comprise PCM disposed within a foam or within a grid structure. Further, the PCM component described herein may also be disposed within a metallic matrix or other high thermal conductivity matrix.

Alternatively, in other implementations, the PCM component of a sheet described herein comprises, is, or is formed from a so-called brick, block, or portion of PCM that is not encapsulated or disposed within another material (such as a plastic pouch or sheet), but is instead disposed between the first and second films of the sheet without any other containment. For example, in some embodiments, the PCM component is not microencapsulated or disposed in a foam. In some such cases, the PCM component comprises a “solid-to-gel” or “solid-to-solid” brick or block.

In addition, a sheet described herein (or a given “PCM component” described herein) can comprise a plurality of differing PCMs, such as those described hereinabove. For example, in some cases, a sheet described herein comprises a first PCM component and a second PCM component, wherein the first and second PCM components are formed from differing materials and have differing phase transition temperatures. The first and second PCM components can be disposed in different PCM-containing zones of the sheet, or in the same PCM-containing zone. Moreover, in some embodiments, a first phase transition temperature of the first PCM component and a second phase transition temperature of the second PCM component (e.g., a first melting point of the first PCM component and a second, different melting point of the second PCM component) are selected to complement each other. For instance, in some cases, the first phase transition is within a first temperature range described herein (such as 2 to 8° C.), and the second phase transition is within a second temperature range described herein (such as 20 to 25° C.), where the first and second temperature ranges correspond to different temperature control ranges or ambient conditions (e.g., winter and summer conditions). A plurality of differing PCM components having a plurality of differing phase transition temperatures can also be used in a “nested” or “staged” manner. For instance, in some cases, a first PCM component has a phase transition temperature that is 5-20° C., 5-10° C., or 10-30° C. higher or lower than the phase transition temperature of a second PCM component. Further, in some such cases, the first PCM component (e.g., the PCM component with the higher phase transition temperature) can be disposed in a PCM-containing zone of the sheet that is closer to the external environment of the sheet (as compared to being closer to a payload contained with a package formed from the sheet, as described further hereinbelow), and the second PCM component (e.g., the PCM component with the lower phase transition temperature) can be disposed in a PCM-containing zone of the sheet that is farther from the external environment of the sheet (and closer to the payload). It is to be understood that a sheet described herein can comprise more than two differing PCMs, PCM components, or PCM-containing zones. In general, a sheet described herein can comprise “n” PCMs, PCM components, or PCM-containing zones, where n can be an integer from 1 to 1000, 1 to 100, 1 to 50, or 1 to 10, and where any two of the n PCMs, PCM components, or PCM-containing zones can have the same or differing phase transition temperatures.

Additionally, in some preferred embodiments, a sheet described herein includes multiple PCM-containing layers or laminates, as opposed to only having one PCM component disposed between only one first film and one second film. For example, in some cases, a sheet described herein further comprises a third film in facing opposition to the first or second film, and a second PCM component disposed in between the third film and the first or second film. Moreover, in still other embodiments, the sheet further comprises a fourth film in facing opposition to the first or second or film, and a third PCM component disposed in between the fourth film and the first or second or third film.

More generally, it is to be understood that a sheet described herein can comprise a stack or laminate of m films that are parallel or substantially parallel to one another and that contain up to (m-1) PCM-containing layers in between the films, such as in an alternating or sandwich arrangement. As above, m can be any integer not inconsistent with the objectives of the present disclosure, such as an integer between 2 and 20, between 2 and 10, between 3 and 20, between 3 and 10, between 5 and 20, or between 5 and 10.

Further, the differing PCM-containing layers can comprise PCM components that are the same or different than one another in terms of composition or phase transition temperature, including in a manner to achieve complementary or “staged” temperature control zones, regions, or gradients.

Moreover, it is further to be understood that the lateral PCM-containing zones and PCM-free fold or cut lines of the sheet can be aligned from layer to layer, such that folding or cutting along the fold or cut zones or lines can be carried out through all the layers of the stack or laminate without cutting or folding a PCM component in any of the layers.

The PCM-free fold or cut zones (or lines) of a sheet described herein do not comprise PCM or a PCM component. That is, moving downwardly (which can be defined as moving in the z-direction) from the lateral plane of the sheet (which can be defined as the xy-plane of the sheet, which is also generally the major or largest plane of the sheet) within the PCM-free fold or cut zones results in not encountering PCM. In other words, within a volume or volumes defined by the PCM-free fold or cut zones in the xy-plane and the total thickness of the sheet in the z direction, there is no PCM or substantially no PCM (less than 1% of the total weight of PCM in overall sheet). As described above, the absence or substantial absence of PCM in these zones can permit the overall sheet to be folded or cut without releasing PCM or straining the films due to folding PCM onto itself. Moreover, when self-adhering films are used and the sheet is cut in this manner, the cut areas can be “resealed” following such a cut, if desired.

A sheet having such a structure and such properties as described herein can be used in a modular manner for packaging applications. For example, in some cases, a user can cut and/or fold a temperature control sheet described herein to achieve a desired package size or to encapsulate or form a package out of a payload having any size sufficiently small to be “wrapped” or covered by the initial sheet that was cut or folded. Modular packaging sheets described herein can thus permit versatile “user-defined” or “user-controlled” packaging of temperature-sensitive items (such as food, pharmaceuticals, blood, tissue, or other chemical or biological materials) while reducing waste due to unnecessarily large envelopes or packages that may be available in only one or a small number of specific sizes.

Moreover, the PCM-free fold or cut zones or lines of a sheet described herein can be marked or otherwise delineated on the sheet to enable an end user to fold or cut the sheet safely (that is, without puncturing or releasing PCM during a cutting or folding process, and without introducing undue film strain during a folding process). For example, in some cases, the PCM-free fold or cut zones are delineated on a surface of the first film and/or second film, using dashed or colored lines or other visual cues or textural cues differentiating the PCM-free zones from PCM-containing zones. Techniques such as mechanical stamping or pressing may be used to define the cut lines or the fold lines.

Sheets described herein can be used to form a temperature control package (e.g., for shipping pharmaceuticals or food) by cutting, folding, and/or self-adhering a single sheet, or by combining a plurality of sheets in various ways. For example, in some preferred embodiments, a single sheet (such as a sheet described above) is used to form a package by (i) placing a payload on the sheet, (ii) cutting the sheet along one or more PCM-free fold or cut zones or lines, (iii) folding the sheet over the payload, and (iv) adhering at least one film of the sheet to itself or to another film of the sheet, thereby encapsulating the payload. In some especially preferred embodiments, the sheet comprises at least one self-adhering film, and this film is adhered to itself or to another film by applying pressure by hand, without heating. In this manner, a temperature control envelope or envelope-like mailer can be formed, including in a desired, user-defined size.

Thus, in some embodiments, a temperature package is described herein, wherein the package comprises a sheet described herein, wherein the sheet is adhered to itself to define an interior volume operable to contain a payload. In some cases, the package is an envelope or mailer. In other embodiments the single sheet is folded unto itself and forms a box or container. Furthermore, the single sheet may be used in a more expansive box by increasing the overall size of the sheet along with cut lines. A variety of configurations may be manipulated to house a variety of materials, as will be known through this disclosure and by those of skill in the art.

It is also possible to form a package using a plurality of sheets described herein, rather than only one sheet. For example, in some instances, a box or box-like package can be formed by adhering two or more (e.g., 2-6) sheets together (e.g., by using each of 6 sheets to define one side of a box, and adhering the sheets together at the edges and/or corners to form the box). Sheets described herein can be used to form packages in other ways as well. Further, such a package described herein can include one or more additional, useful features. For example, in some embodiments, a package or a sheet forming a portion thereof comprises one or more fold lines that provide collapsibility to the package (by folding along the fold lines). Moreover, in some cases, the one or more fold lines correspond to or are PCM-free fold or cut zones of a sheet described herein.

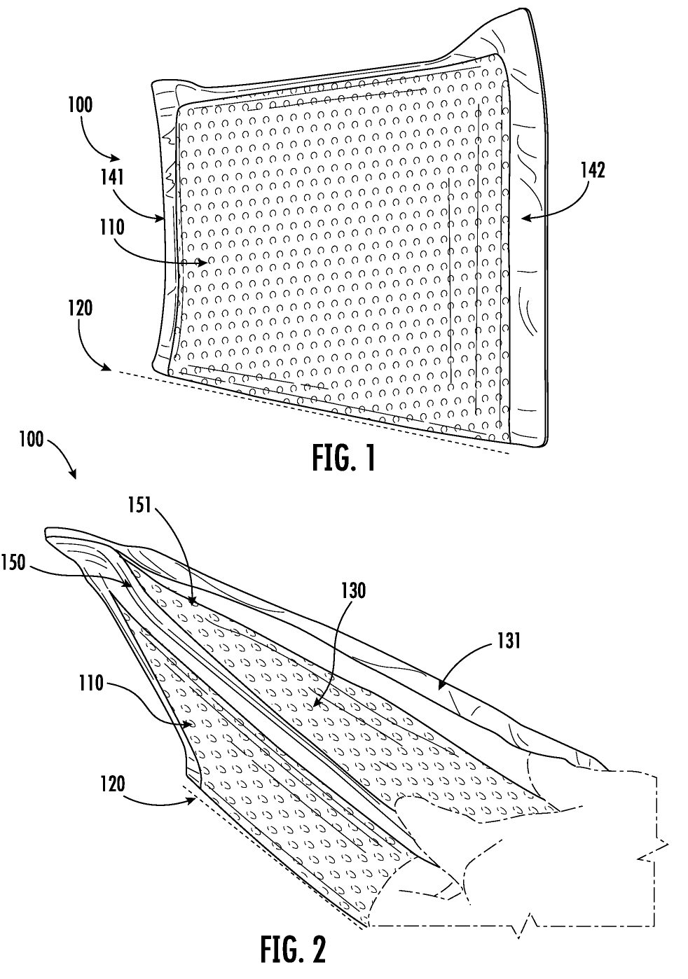

Some non-limiting examples of sheets and packages described herein will now be further described with reference to the figures. FIGS. 1 and 2 illustrate perspective views of a package in the form of an envelope or mailer (100). The envelope (100) is shown with an elevational perspective lying flat in FIG. 1, and in open configuration in FIG. 2. The envelope (100) is formed from a sheet (110) folded approximately in half at a PCM-free fold zone or line (illustrated as dashed line 120), thereby forming or defining an interior volume (130). A payload (not shown) may be placed in the interior volume (130) through the opening (131). As illustrated in FIGS. 1 and 2, the opening (131) is an unsealed region where the sheet (110) has not yet been connected or adhered together to close the envelope (100). In the example of FIG. 1, the two edges (141, 142) of the envelope (100) have been sealed by manually pressing together the bottom, self-adhesive side (151) of a self-adhesive first film (150), which is also the “bottom” of the overall laminate sheet (110).

In the example of FIG. 2 the PCM-free fold zone (120) is configured to accept a fold and not damage or otherwise interfere with the PCM material disposed within the temperature control sheets. In the example embodiments of FIGS. 1 and 2 it is shown how the temperature control sheets may be manufactured in similar concept to current bubble mailer manufacturing processes, by incorporating additional steps of integrating the layers of temperature control sheets and by customizing the manufacturing to a specific application.

Furthermore, in the example of FIGS. 1 and 2 the two edges (141, 142) may also be defined as a third or fourth edge, wherein a pouch entryway is formed to allow a fold over design of a mailer (not depicted). The configuration in FIGS. 1 and 2 is but one of any configurations that would be suitable as a mailer for transport through commercial mail centers. The variety of configurations may be implemented by a series of folds wherein the PCM-free fold zones enable bending, adhering, gluing, stapling, and a many other mechanical or physical changes that the base substrate material (typically a polymer) will allow.

In the example of FIGS. 1 and 2, the mailer may be comprised of a fabric mailer wherein the temperature control sheets are integrated within the walls of the mailer. In further aspects, the fabric mailer may be doped or otherwise integrated with PCM material so that the temperature control sheets are embedded within the structure of the fabric mailer. Additionally, pouches or sleeves may be located on a mailer in which temperature control sheets are placed and housed within.

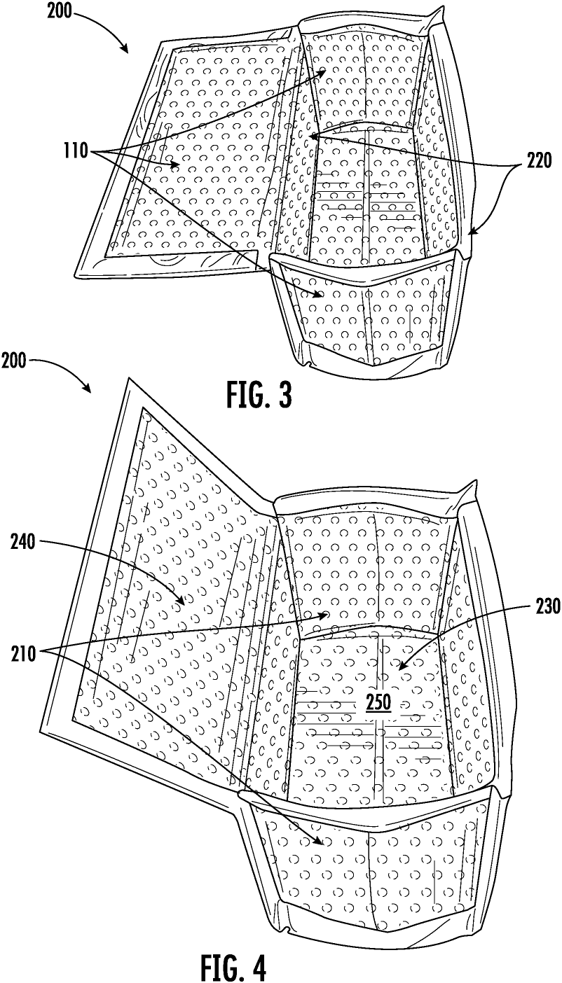

FIGS. 3-7 illustrate perspective views of a package with temperature control sheets in the form of a box (200). The box (200) is formed from a plurality of temperature control sheets (110), so as to define first opposing side walls (210) and second opposing side walls (220), along with a floor (230) and a lid (240). The configuration is but one of many combinations, and the box (200) may take any shape necessary for transporting products that require temperature control and thermal regulation. The side walls (210, 220), floor (230), and lid (240) define an interior volume (250). The example interior volume may be sealed or adhered at the junctions or may be folded in an origami fashion to form the interior volume (250). Furthermore, the interior volume may be sealed to provide further protection, or the interior volume may also be coupled with a bubble mailer on the interior or exterior to provide shock absorption and protection from damage due to falls and or compression. Similarly, the exterior of the sheets that form the box (200) may be covered with a protective layer such as a bubble layer or a layer of packaging insulation, a typical packaging insulation is air, but the insulation may also consist of foam, such as styrofoam sheets, or other material capable of dampening falls and or compression.

FIG. 3 illustrates the box (200) in the open state, while FIG. 4 illustrates the box (200) in a partially closed state, in which the lid (240) has been partially raised in the act of closing the box (200). The open and closed configurations allow for the consumer or user to place items within the interior volume (250) as well as adjust the contents. The open and closed states may be configured to close via adhesion, or in more permanent embodiments via a zipper or interlocking components such as snaps for embodiments that comprise fabric or other durable elements.

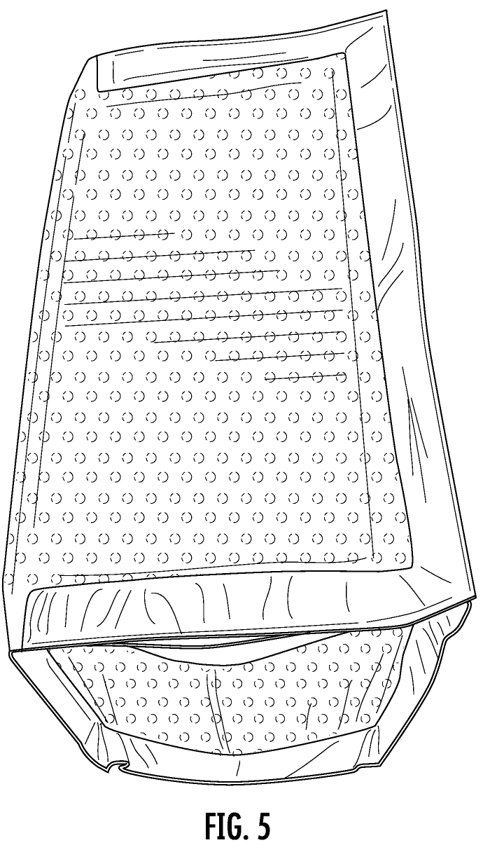

FIG. 5 illustrates the box (200) after the lid (240) has been fully closed. In the example of FIG. 5 the lid (240) may be adhered through an adhesive such as described earlier, or through bonding of the polymers through chemical means or through heating. Furthermore, the choice of adhesion is dependent upon the material used in the sheets and an election of an adhesive or adhesive agent will also further depend on the contents within the interior volume, the temperature, other materials within the box, package, mailer, or envelope, as well as end user desires such as tear open, or cut to open, to name a few.

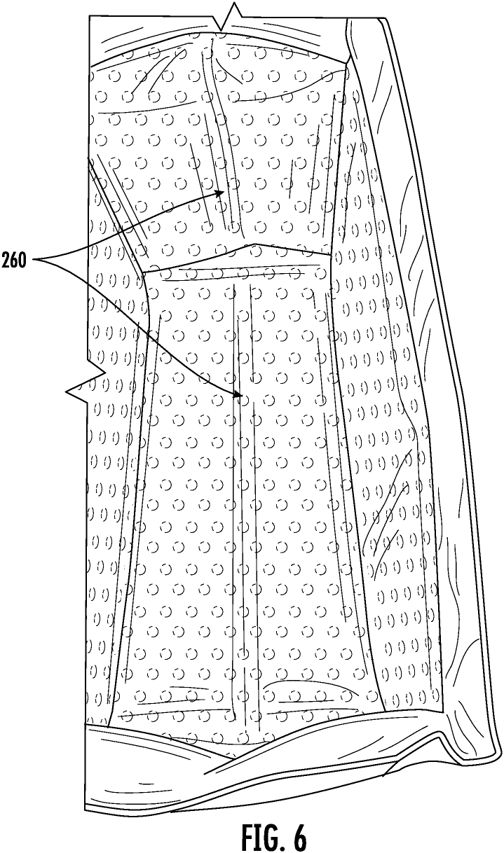

FIG. 6 provides a more detailed view of the interior volume (250). Specifically, in FIG. 6, fold lines (260) are more clearly visible. The fold lines (260) correspond to PCM-free fold or cut zones of the sheet (110) forming the floor (230) and one of the first opposing side walls (210). By, inter alia, folding the first opposing side walls (210) and the floor (230) along the fold lines (260), the box (200) can be collapsed to lie flat. The sheets, in the example, are comprised of a first layer and a second layer, in which PCM is disposed. In additional examples the sheets may consist of a plurality of layers, each with a different or tailored PCM disposed within.

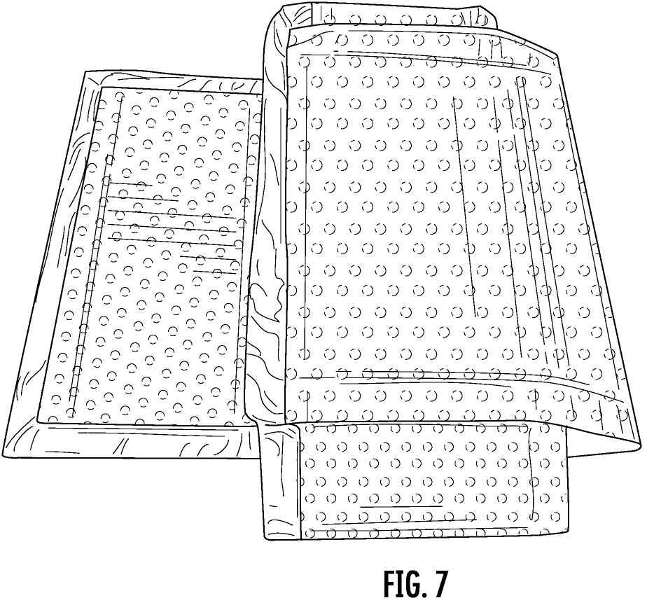

FIG. 7 illustrates the box (200) in its collapsed state. Wherein configuring for a collapsed state allows for large scale production and storage of temperature controlled packaging. Such uses can then be rapidly deployed through a mechanized procedure of unfolding and securing or through a series of defined steps. Additional benefits of the collapsed state include easier transporting as well as protecting the temperature control sheets from damage. Further, the contents become “self-sealed” by bundling large stacks of sheets that are comprised of a polymer, therefore reducing the risk of leaks and or abrasion cuts or tears.

The present disclosure also describes methods of using sheets and packages for transportation or shipping of products, particularly temperature-sensitive products. In some embodiments, such a method comprises placing the product in the interior volume of a package described herein; transporting the product from a first location to a second location; and removing the product from the interior volume of the container. Further, in some instances, the method further comprises heating or cooling the PCM component of the package above or below a phase transition temperature of the PCM component prior to placing the product in the interior volume of the package. For example, in some embodiments, the package is placed in a refrigerator or freezer prior to placing the product in the interior volume of the package.

A method described herein can be used to regulate or control the temperature of any product or payload not inconsistent with the objectives of the present disclosure. For example, in some embodiments, the product or payload comprises a food, a pharmaceutical, a chemical, or biological sample such as blood or biological tissue. The method of doing so in one example include folding a temperature control sheet (comprised of a first film and a second film, with PCM disposed between) into a configurable enveloper, mailer, or package. Wherein the envelope, mailer, or package may be adhered at the lid or top portion with adhesive for sealing the interior volume and the payload or contents of the mailer.

Certain implementations of compositions and methods consistent with the present disclosure are provided as follows.

Embodiment 1. A temperature control sheet comprising:
a first film;
a second film in facing opposition to the first film; and
a phase change material (PCM) component disposed in between the first film and the second film,
wherein the sheet comprises one or more PCM-containing zones in a lateral plane of the sheet; and
wherein the sheet comprises one or more PCM-free fold or cut zones in the lateral plane of the sheet.

Embodiment 2. The sheet of embodiment 1, wherein the sheet comprises a plurality of PCM-containing zones in the lateral plane of the sheet.

Embodiment 3. The sheet of embodiment 1 or embodiment 2, wherein the sheet comprises a plurality of PCM-free fold or cut zones in the lateral plane of the sheet.

Embodiment 4. The sheet of any of the preceding embodiments, wherein the first film and/or the second film is a self-adhering film.

Embodiment 5. The sheet of embodiment 4, wherein the self-adhering film adheres to itself by application of pressure.

Embodiment 6. The sheet of embodiment 4 or embodiment 5, wherein the self-adhering film does not require the application of heat to adhere to itself.

Embodiment 7. The sheet of any of embodiments 4-6, wherein the self-adhering film does not require or comprise a separate adhesive layer, strip, or area for the purpose of adhering the film to itself.

Embodiment 8. The sheet of any of the preceding embodiments, wherein the first film and/or the second film further comprises a separate adhesive layer or region.

Embodiment 9. The sheet of any of the preceding embodiments, wherein the PCM component comprises a mat or sheet comprising one or more pouches that contain PCM.

Embodiment 10. The sheet of any of the preceding embodiments, wherein the PCM component comprises a portion of PCM that is not encapsulated or disposed within another material.

Embodiment 11. The sheet of any of the preceding embodiments, wherein the sheet comprises a plurality of differing PCM-containing zones and the differing PCM-containing zones comprise differing PCM components having differing phase transition temperatures.

Embodiment 12. The sheet of any of the preceding embodiments, wherein the sheet further comprises:
a third film in facing opposition to the first or second film; and
a second PCM component disposed in between the third film and the first or second film.

Embodiment 13. The sheet of embodiment 12, wherein the sheet further comprises:
a fourth film in facing opposition to the first or second or film; and
a third PCM component disposed in between the fourth film and the first or second or third film.

Embodiment 14. The sheet of any of the preceding embodiments, wherein the PCM-free fold or cut zones are delineated on a surface of the first film and/or second film.

Embodiment 15. A method of forming a temperature control package, the method comprising:
placing a payload on the sheet of any of embodiments 1-14;
cutting the sheet along one or more PCM-free fold or cut zones of the sheet;
folding the sheet over the payload; and
adhering at least one film of the sheet to itself or to another film of the sheet, thereby encapsulating the payload.

Embodiment 16. The method of embodiment 15, wherein:
the sheet comprises at least one self-adhering film; and
adhering comprises applying pressure to the self-adhering film by hand, without heating.

Embodiment 17. A temperature control package comprising:

the sheet of any of embodiments 1-14, wherein the sheet is adhered to itself to define an interior volume operable to contain a payload.

Embodiment 18. The package of embodiment 17, wherein the package is an envelope or mailer.

Embodiment 19. A temperature control package comprising:
two or more sheets according to any of embodiments 1-14,
wherein the two or more sheets are adhered to one another to define an interior volume operable to contain a payload.

Embodiment 20. The package of embodiment 19, wherein the package is a box.

Embodiment 21. The package of embodiment 19 or embodiment 20, wherein at least one side of the package comprises a fold line operable to collapse the package by folding.

Embodiment 22. A method of transporting a product, the method comprising:
placing the product in the interior volume of the package of any of embodiments 17-21;
transporting the product from a first location to a second location; and
removing the product from the interior volume of the container.

Embodiment 23. The method of embodiment 22, wherein the method further comprises heating or cooling the PCM component of the package above or below a phase transition temperature of the PCM component prior to placing the product in the interior volume of the package.

Embodiment 24. The method of embodiment 22 or embodiment 23, wherein the product comprises a food, a pharmaceutical, a chemical, and/or a biological sample.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A temperature control sheet comprising:
a first film;
a second film in facing opposition to the first film; and
a phase change material (PCM) component disposed in between the first film and the second film, wherein the sheet comprises one or more PCM-containing zones in a lateral plane of the sheet; and
wherein the sheet comprises one or more PCM-free fold or cut zones in the lateral plane of the sheet.

2. The sheet of claim 1, wherein the sheet comprises a plurality of PCM-containing zones in the lateral plane of the sheet.

3. The sheet of claim 1, wherein the sheet comprises a plurality of PCM-free fold or cut zones in the lateral plane of the sheet.

4. The sheet of claim 1, wherein the first film and/or the second film is a self-adhering film.

5. The sheet of claim 4, wherein the self-adhering film adheres to itself by application of pressure.

6. The sheet of claim 4, wherein the self-adhering film does not require the application of heat to adhere to itself.

7. The sheet of any of claims 4, wherein the self-adhering film does not require or comprise a separate adhesive layer, strip, or area for the purpose of adhering the film to itself.

8. The sheet of claim 1, wherein the first film and/or the second film further comprises a separate adhesive layer or region.

9. The sheet of claim 1, wherein the PCM component comprises a mat or sheet comprising one or more pouches that contain PCM.

10. The sheet of claim 1, wherein the PCM component comprises a portion of PCM that is not encapsulated or disposed within another material.

11. The sheet of claim 1, wherein the sheet comprises a plurality of differing PCM-containing zones and the differing PCM-containing zones comprise differing PCM components having differing phase transition temperatures.

12. The sheet of claim 1, wherein the sheet further comprises:
a third film in facing opposition to the first or second film; and
a second PCM component disposed in between the third film and the first or second film.

13. The sheet of claim 12, wherein the sheet further comprises:
a fourth film in facing opposition to the first or second or film; and
a third PCM component disposed in between the fourth film and the first or second or third film.

14. The sheet of claim 1, wherein the PCM-free fold or cut zones are delineated on a surface of the first film and/or second film.

15. A method of forming a temperature control package, the method comprising:
placing a payload on the sheet of claim 1;
cutting the sheet along one or more PCM-free fold or cut zones of the sheet;
folding the sheet over the payload; and
adhering at least one film of the sheet to itself or to another film of the sheet, thereby encapsulating the payload.

16. The method of claim 15, wherein:
the sheet comprises at least one self-adhering film; and
adhering comprises applying pressure to the self-adhering film by hand, without heating.

17. A temperature control package comprising:
the sheet of any of claims 1,
wherein the sheet is adhered to itself to define an interior volume operable to contain a payload.

18. The package of claim 17, wherein the package is an envelope or mailer.

19. A temperature control package comprising:
two or more sheets according to claim 1,
wherein the two or more sheets are adhered to one another to define an interior volume operable to contain a payload.

20. The package of claim 19, wherein the package is a box.

21. The package of claim 19 , wherein at least one side of the package comprises a fold line operable to collapse the package by folding.

22. A method of transporting a product, the method comprising:
placing the product in the interior volume of the package of any of claims 17;
transporting the product from a first location to a second location; and
removing the product from the interior volume of the container.

23. The method of claim 22, wherein the method further comprises heating or cooling the PCM component of the package above or below a phase transition temperature of the PCM component prior to placing the product in the interior volume of the package.

24. The method of claim 22 , wherein the product comprises a food, a pharmaceutical, a chemical, and/or a biological sample.
